(19) United States
(12) Patent Application Publication
(10) Pub. No.: US 2009/0277321 A1
(43) Pub. Date: Nov. 12, 2009

(54) PORTABLE INTERFACE DEVICE AND SYSTEM INCORPORATING SUCH DEVICE

(75) Inventor: Keith Sturch, Birmingham (GB)

Correspondence Address: BROOKS KUSHMAN P.C., 1000 TOWN CENTER, TWENTY-SECOND FLOOR, SOUTHFIELD, MI, 48075, US

(73) Assignee: SPLASHPLAY LTD, Birmingham (GB)

(21) Appl. No.: 11/722,203

(22) PCT Filed: Dec. 22, 2005
(86) PCT No.: PCT/GB05/04991

§ 371 Date: Jun. 20, 2007

(30) Foreign Application Priority Data
Dec. 22, 2004 (GB) 0428069.9

(51) Int. Cl. G09B 15/02

(52) U.S. Cl. 84/477 R

(57) ABSTRACT

The present invention relates to a portable interface device (10) and to a system incorporating the device. Embodiments include a music tuition system comprising an electronic digital data processing unit (12) capable of accessing a store of electronic music data of a pre-determined format and a luminary display (14) mountable on a musical instrument (20). The interface device (10) is a user controllable electronic interface device mountable to the musical instrument and includes a memory (18) for storing data and means for receiving music data from the data processing unit (12). The interface device includes means for generating command signals for controlling the luminary display in accordance with a sequence determined from the music data, and means (16) for a user to control output of the music data to the luminary display (14).

The present invention relates to a portable data communications interface device and to systems incorporating such a device. More particularly, but not exclusively, the invention relates to an interface device that facilitates improvements in musical tuition systems. A presently preferred embodiment of the present invention comprises a system to provide users with the opportunity to learn music with a ‘hands-on’ approach on their existing instruments by using their mobile phone, PDA or personal computer.

### DISCUSSION OF PRIOR ART

Known musical tuition systems and devices exist that are predominantly based in the United States. Patents cited are U.S. Pat. Nos. 4,318,327, 5,408,914, 4,791,848, 4,807,509, 4,901,618, 4,080,867, 6,452,081, 6,296,489.

In particular, U.S. Pat. No. 6,452,081 discloses a device for teaching students of stringed instruments note locations and proper finger placements on the fingerboard of the instrument. This is done by using a computer that has a source of music, such as an instrument pick-up, which supplies music to the computer. The computer then analyses this music into tonal patterns on a target instrument such as a guitar. The computer is hard-wired (either directly or via an interface driver if no suitable computer output port is available) to a fingering guide, which is placed on the fretboard of the target instrument. The fingering guide incorporates light sources which light up to indicate where the music student should place their fingers on the fretboard of the instrument to re-create on their instrument the piece of music being supplied to the computer. A disadvantage associated with this system is the fact that the student is effectively “tied” to their computer—the computer supplies the electrical signals to light the fingering guide in real time, and hence the wiring between the fingering guide (and effectively the musical instrument, therefore) must be maintained, which may be impractical and/or uncomfortable for the student. Also, the student is not provided with a convenient means for controlling the flow of electrical information to the fingering guide, and hence cannot fast-forward, pause or play certain sections at a lower tempo, for example.

Another musical tuition system is the “Fretlight Learning System”, advertised on the website www.optekmusic.com. This comprises a specially constructed guitar having LED lights permanently installed in the fingerboard of the guitar. The guitar may then be wired to a PC (e.g. via a USB port), which lights up the LEDs according to what fret is supposed to be pressed to re-create a particular chord or note. A problem associated with this system is that a tutee must buy the entire instrument on which they are to be taught, and cannot use a presently owned instrument, or an instrument available for hire from a music shop, for example. Furthermore, if any damage is done to the LEDs in the fretboard of the guitar, it is possible that the entire neck of the guitar may require (costly) replacement.

It is desired to overcome or substantially reduce at least some of the problems described above and to provide an improved musical tuition system. It is further desired to provide an improved portable interface device for use in a variety of systems, including such a musical tuition system.

### DISCUSSION OF THE INVENTION

According to first aspect of the present invention, there is provided a music tuition system comprising: an electronic digital data processing unit capable of accessing a store of electronic music data of a pre-determined format; a luminary display mountable on a musical instrument; and a user controllable electronic interface device mountable to the musical instrument and including a memory for storing data, means for receiving music data from the data processing unit and for generating command signals for controlling the luminary display in accordance with a sequence determined from said music data, and means for a user to control output of the music data to the luminary display.

According to a second aspect of the present invention there is provided a user controllable electronic interface device mountable to a musical instrument and operable for providing command signals for control of a luminary display on said instrument, wherein the interface device comprises: a memory for storing electronic data that includes music data; means for generating said command signals for controlling the luminary display in accordance with a sequence determined from said music data; means for receiving said electronic data for storage in the memory; and means for a user to control output of the command signals to the luminary display.

A presently preferred embodiment of the present invention comprises a music tuition system comprised of three elements to teach music on a variety of different instruments.

The first element, discussed in greater detail later, is an electronic digital data processing unit and preferably comprises an external, intelligent, on-line unit capable of accessing a store of electronic music files held in a pre-determined format. The first element may, for example, comprise a personal computer (PC), personal digital assistant (PDA) or mobile telephone capable of accessing a store of electronic music files via the Internet. Preferably, the music files are in MIDI (Musical Instrument Digital Interface) format, although with suitable software other file types e.g. MP3 format files could be used. This first element is able to send the acquisitioned MIDI file as it is, to the second element, which is a user controllable portable interface device wherein the portable device will transpose the MIDI file into the necessary signals needed to power the third element, which is a luminary panel; or the first element may (through the application software) be able to download the MIDI files, transpose them accordingly arid then send a revised digital file to the user controllable portable interface device. The user controllable portable interface device may then be used to power the luminary panel in accordance with the data it has received. This will nominally increase the speed of download time to lighting the luminary panel since all processing may be done on the first element, the intelligent, on-line unit.

The first element transfers or downloads the accessed song information onto the second element of the system, which comprises a control unit herein called the user controllable, portable interface device and a user control interface. The data download is via either a wireless (BlueTooth) or hardwired (USB) connection. On download, the song information, (e.g. in MIDI format) is stored into a non-volatile memory module of the user controllable portable device, which is retained in memory even if the battery supply is removed. From this storage area, and using the user control interface, the user can start and stop play of the said MIDI file, for example, as discussed in greater detail hereinafter.

The third element (also discussed in greater detail later) comprises a positional display indicator panel, which is preferably an electro-luminescent, luminary panel. Other technologies available for use include printed plastic electronic circuits by Plastic Logic Limited and LEPs (Light Emitting Polymers) made by Cambridge Display Technologies and the possible use of super-slim LED's (Light Emitting Diodes). As the music file stored on the user controllable, portable device is sequenced through, a microcontroller within the user controllable portable interface device outputs the necessary command signals required to control the luminary display's internal processor, which is preferably connected via a SPI or IIC serial interface. The user controllable, portable device is able to drive different luminary panels that are attachable to different instruments. In the case of a stringed instrument, for example, these luminary panels display to the user which strings to play on their instrument and also where to “fret” the string on the neck of the instrument (or simply indicate that an “open” i.e. unfretted string is to be played). Alternatively, a panel can be used to display, which keys of a keyboard are to be played, and so forth. Attachment of these panels is on the neck of a guitar (under the strings), for example, or on top of the keys on a keyboard/piano or simply wrapped around a recorder/flute by way a tube-shaped design. The conversion of the MIDI file to a series of signals (pulses variable in duration), which drive the lights in the electro-luminiscent indicator panel is straightforward and is not described in any further detail herein.

Each luminary panel has a nominal thickness and as such forms a membrane so that when the panel is attached to the desired instrument, it offers negligible aesthetic intervention, if at all.

The present invention offers an autonomous ‘box of electronics’ that is totally portable. This embodiment of electronics is able to receive and store musical data (namely MIDI files), from a plethora of internet sources. These sources include personal computers and more specifically GPRS telecommunication devices, i.e. 3G phones, PDAs (Personal Digital Assistants) for example. Once the song information is stored, the user controllable, portable device acts independently from the intelligent, on-line device.

According to another aspect of the present invention there is provided a music tuition method comprising: accessing a store of electronic music data of a pre-determined format; transmitting music data to a user controllable electronic interface device mounted on a musical instrument; storing the music data in a memory on the interface device; and controlling the interface device to generate command signals for operating a luminary display on the musical instrument in accordance with a sequence determined from said music data.

According to a further aspect of the present invention there is provided a portable electronic interface device comprising: a memory for storing data and software; first transceiver means for two-way communications with a remote data acquisition device; second transceiver means operable for two-way communications with a portable display device; and a processor for implementing instructions contained in said software to cause said interface device to transmit signals for controlling said remote device to acquire data, to retrieve said acquired data therefrom, and to transmit information based on said retrieved data to said portable display device for display thereon.

In one embodiment, the portable electronic interface device comprises user operable control features enabling a user to control operation of the device. In another embodiment, the portable display device comprises user operable control features for enabling a user to generate control signals for transmission via the second transceiver means to the remote device for control thereof. The portable display device may be a mobile telephone or similar device.

The remote device may be any device that monitors sensors or apparatus for obtaining physical data. The remote device may a health checker. The health checker may be operable for monitoring any or all of blood pressure, body temperature, pulse rate, insulin level. Alternatively the remote device may be a weather station. The weather station may be operable for obtaining data relating to any or all of, wind speed, wind direction, atmospheric temperature, pressure and humidity.

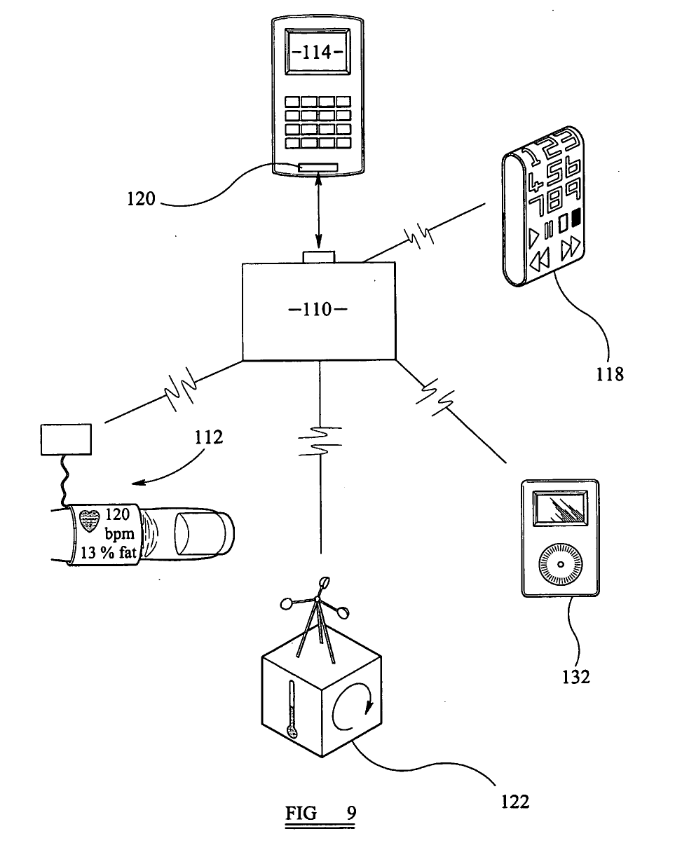

In an alternative configuration, the portable display device may be remote from the interface device. In this configuration, the two-way communications with the interface device may be wireless or by way of a cable. In one embodiment, the portable display device is a light band worn on a user's wrist or releasably attached (e.g. by Velcro™) onto the sleeve of a coat. In one embodiment, the portable display device is configured to communicate via the interface device to control operation of the remote device. For example, the remote device may be an MP3 player, or similar type of device that would otherwise be inaccessible in the user's coat pocket (see 132, FIG. 9)

Embodiments of the present invention will now be described with reference to the accompanying drawings, summarised briefly as follows.

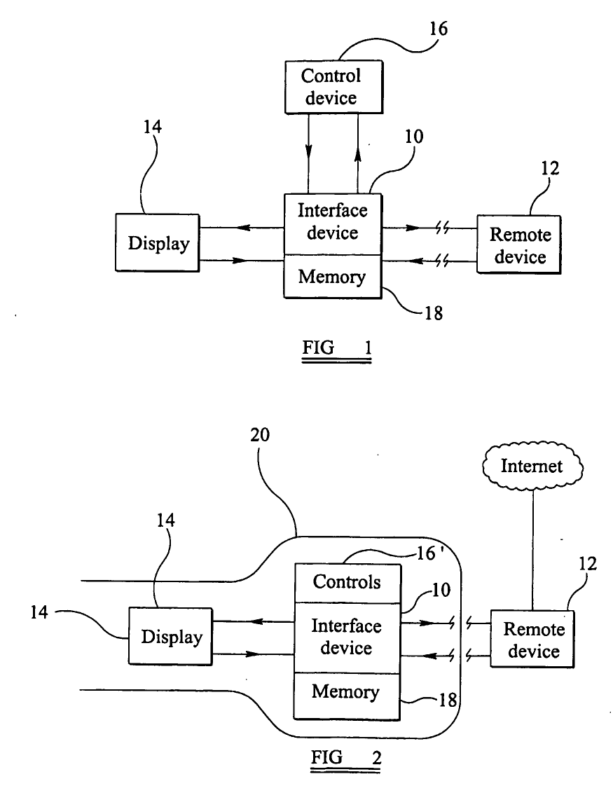

FIG. 1 is a schematic illustration of the principal components that make up a digital data communications and display system on which the present invention is based

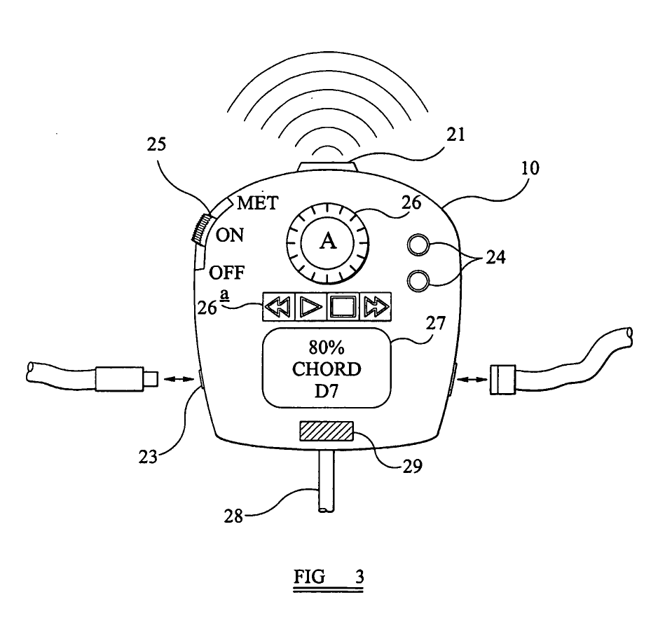

FIG. 2 is a schematic illustration of the principal components of an embodiment of a music tuition system in accordance with the present invention.

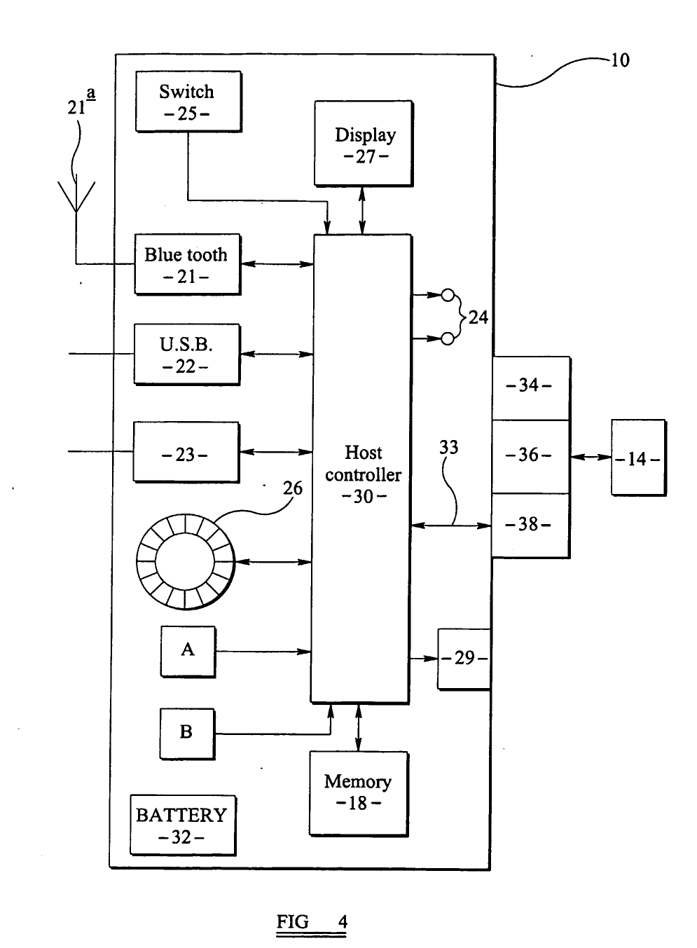

FIG. 3 depicts an interface device for use in the music tuition system of FIG. 2.

FIG. 4 details an outline of the electronic schematics of the interface device of FIG. 3.

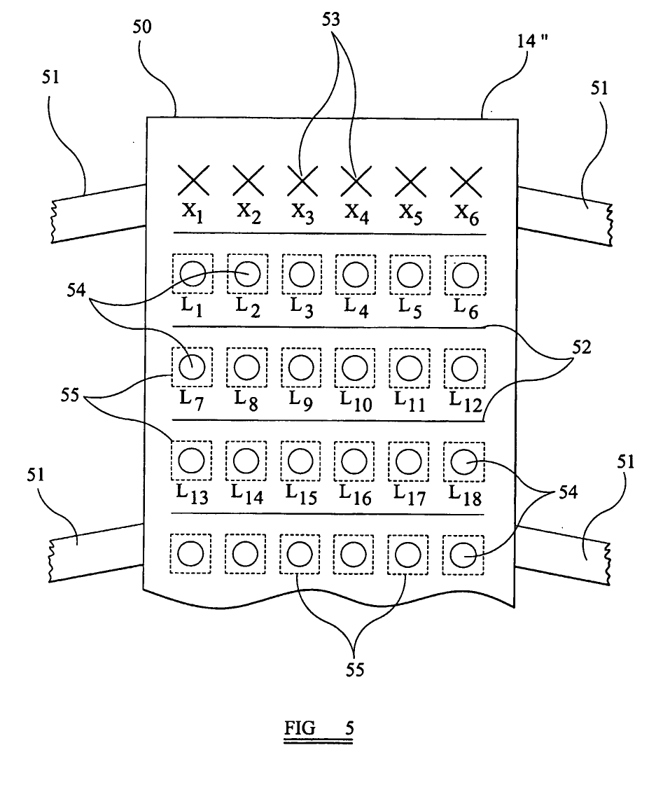

FIG. 5 depicts an electroluminescent panel for use in the music tuition system of FIG. 2.

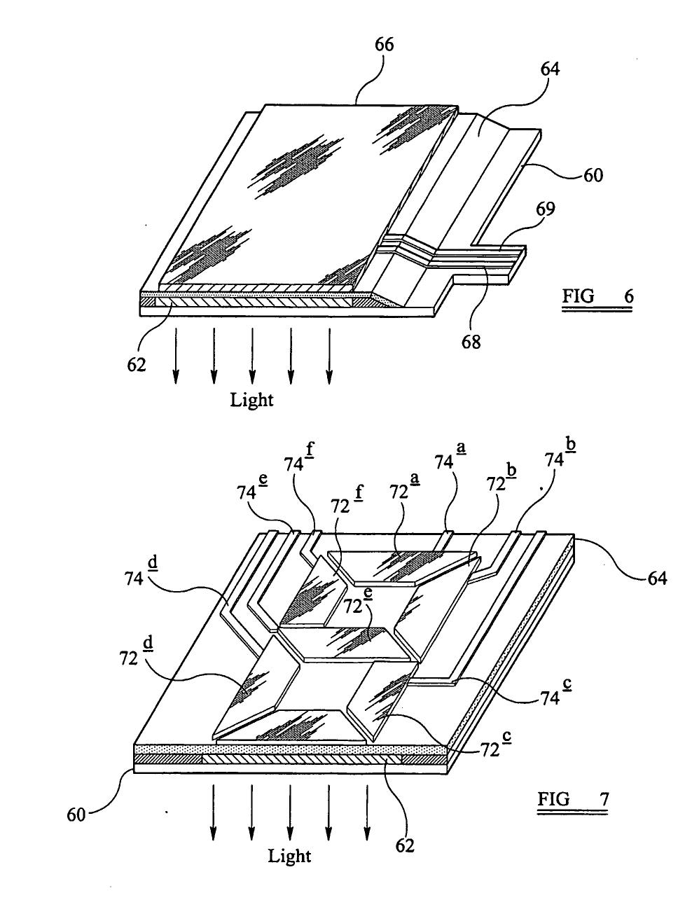

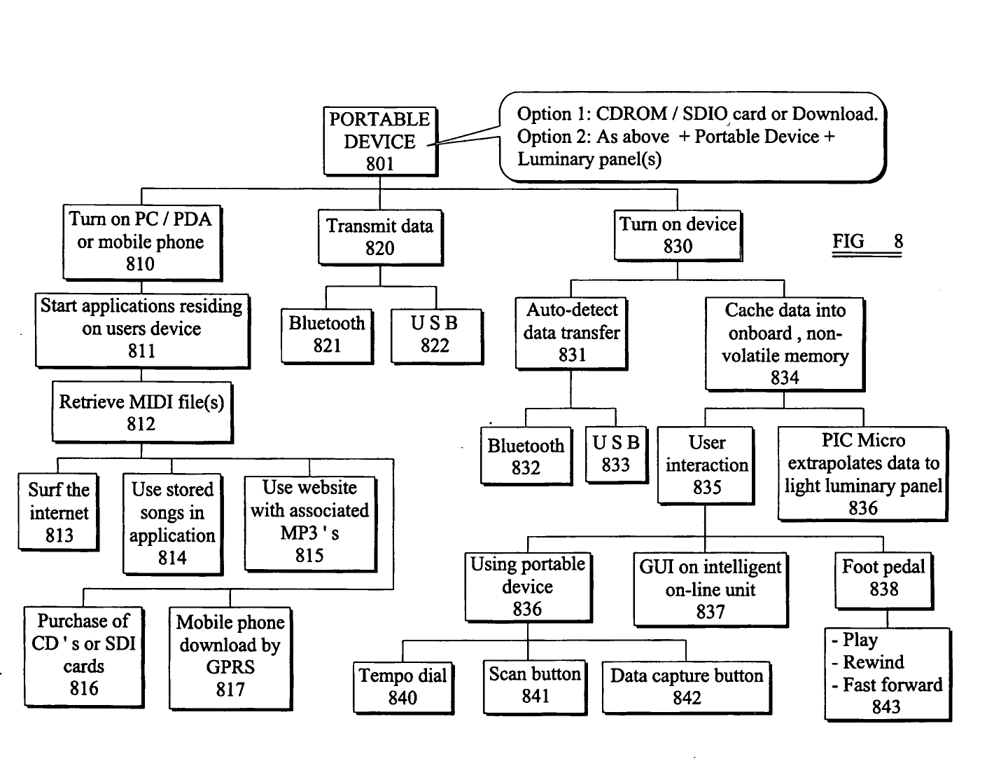

FIGS. 6 and 7 depict a section through electroluminescent panels of the type depicted in FIG. 5.

FIG. 8 is a chart depicting the steps for user interaction with the music tuition system of FIGS. 2 to 5.

FIG. 9 is a schematic representation of an arrangement of the principal components that make up some alternative embodiments of a data communications system in accordance with the present invention.

Referring to FIG. 1, the principal components that make up a digital data communications and display system on which the present invention is based, include an interface device 10, a remote device 12 holding data accessible by the interface device, a display 14 and a control device 16. The interface device 10 includes a memory 18 for storing data and software. Data is transferred between the interface device 10 and the other devices 12, 14, 16 either along data communications cables or through wireless communications (e.g. Bluetooth). As will be apparent from the following description, an important feature of the interface device 10 is that it should be a stand-alone portable device. By this is meant that the interface device 10 can be operated and controlled without the need for a permanent wired connection to a source of data or a source of power. The interface device 10 is also of a size and weight suitable for carrying in a pocket, being held in one hand, or being mounted to a musical instrument so as not to impair playing of the instrument.

FIG. 2 represents an embodiment of a music tuition system according to the invention, in which the interface device 10′ and the display 14′ are mounted to a musical instrument 20. In this embodiment, the control device 16′ is incorporated into the interface device 10′, for example taking the form of push buttons or dials on an outer surface of the interface device 10′. The display 14′, an example of which is described in more detail hereafter, typically includes markers or spots that can be illuminated under the control of command signals sent from the interface device 10′, illuminated markers indicating fingering positions to produce a particular musical note or chord on the musical instrument 20. As both the interface device 10′ and the display 14′ are mounted on the musical instrument 20, the data communications are preferably by way of a cable between these devices. In contrast, the remote device 12′ is not coupled to the interface device 10 by a cable, at least while the interface device 10′ is being used to send command signals to control operation of the display 14. Instead the remote device 12 is only coupled to the interface device 10′ for the purpose of transmitting digital music data (e.g. MIDI files) to the interface device 10′. This may be accomplished by a temporary cable link (e.g. through a USB connection) or preferably by wireless (e.g. Bluetooth) communications.

As illustrated in FIG. 2, the musical tuition system essentially comprises three elements. The first element of the system is the remote data holding device 12′, which is an electronic digital data processing unit, and preferably comprises a PC/PDA/mobile telephone capable of accessing a store of electronic music files, for example via the internet. The second element is the interface device 10′. The third element is an electroluminescent display panel 14′.

Citing an example of the first element 12′ for the point of illustration, would be the use of a user controllable, portable device with mobile telephony; internet-enabled, mobile phones are able to download the present invention's application software. The user then is able to search the Internet on their mobile phone via the software application. Once the desired song information has been found and downloaded into the application, the user is able to use either the GUI (Graphical User Interface) residing on the mobile phone to then understand and learn how the chosen music file is composed or the user can choose to transmit this file or indeed, numerous files, to the second element, which is a user controllable portable interface device 10′.

Features of the user controllable portable interface device 10′ are set out in the following bullet-points referring to FIGS. 3 and 4:
BlueTooth and USB connectivity input MIDI files via either a wireless BlueTooth input 21 or USB connection 22. Java software on the user's on-line, intelligent device extrapolates the MIDI file and transmits the necessary part relevant to the panel they are using, e.g. guitar part of MIDI for guitar panel or piano part of MIDI for keyboard panel. Onboard electronics store several MIDI files in a non-volatile memory module of the interface device 10′, for example saving the user download time each time they turn the unit on.
A port 23 on the interface device 10′ also allows connection to a MIDI keyboard.
Button A on the interface device 10′ allows data capture. For example as the MIDI file is played the user clicks button A to start data capture then button A again to stop the data capture. The electronics then loop this captured segment of the MIDI file until the user presses the play button whereby the MIDI file continues to play from where it was stopped.
A tempo dial 26 on the interface device 10′ slows the MIDI file down i.e. it will slow the speed at which the device lights the panel.
Touch control buttons 26a allow for play, stop, pause, fast-forward and reverse functions.
A metronome is provided. A 3-way switch 25 on the interface device incorporates ON, OFF & METRONOME. This just flashes an LED 24 at the desired speed, which uses the tempo dial for dual functionality. This set BPM (beats per minute) is shown on an LCD 27 as 120 bpm for example. A small piezo-electric speaker then gives an acoustic representation of this user input.
An LCD screen 27 is provided. Onboard software identifies and displays a chord name whenever it arises. For example, a luminary display 14″ for use on a guitar is shown in FIG. 5; if lights L5, L9 and L14 on the luminary display 14″ attached to the guitar are to be lit and this corresponds to a C chord, then the LCD 27 displays “C chord”.

A complimentary foot pedal (not shown) ‘mirrors’ and/or supplements most of the controls on the interface device 10′. This too communicates with the interface device using USB or BlueTooth protocol and enables the user to STOP, REWIND, FAST-FORWARD, PLAY or PAUSE the onboard MIDI file, for example. The output of the interface device 10′ is through a wire 28. The wire 28 carries the necessary signals needed to power the electroluminescent panel display 14′ accordingly.

A detailed schematic illustration of the circuitry and components that make up the interface device 10′ is shown in FIG. 4. The equivalent features described above referring to FIG. 3 have the same reference numerals. In addition the interface device 10′ includes an embedded host controller 30, which performs the required data processing tasks in accordance with software instructions and data stored in the memory 18′. Memory 18′ is typically an EEPROM. Where the music data files are received from the remote data-holding unit via a wireless Bluetooth connection, the Bluetooth receiver 21 includes an antenna 21a. The host controller 30 generates command signals and transmits them to an interface driver 34. The interface driver 34 includes an ASIC 36 and is provided to generate voltage signals that power the electroluminescent display 14′ in accordance with the command signals. In the embodiment shown, the interface driver 34 and ASIC 36 are attached to the interface device 10′. However, it is also possible to provide these as a separate unit mountable to the instrument and connected by suitable cables to both the interface device and the electroluminescent display 14′. It may also be possible to incorporate the interface driver 34 and ASIC 36 into the electroluminescent display 14′.

It is to be appreciated, though, that the main task of the first element, the remote electronic digital data processing unit 12′, is to provide a music file to the second element, the interface device 10′, and as such could simply be a store of MIDI music files (for example, a PC hard-drive with a selection of music MIDI files pre-loaded thereon).

In any event, the data transfer to the interface device 10′ is, in a presently preferred embodiment, to be done by either a wireless (BlueTooth) or hardwired (USB) connection. Once uploaded to the interface device 10, the user then disconnects from electronic digital data processing unit 12′ (the external, on-line intelligent unit) if a hard-wired connection is used, or disables the wireless Bluetooth connection, and attaches the user controllable portable interface device 10′ onto their chosen instrument by way of a simple clamp or such like. Where a wireless connection is used, however, it is envisaged that a user can simply download files from their mobile telephone, PC etc. to their personal interface device 10′ whilst the interface device 10′ is already clamped to their instrument. Once the interface device 10′ has been loaded with the desired MIDI file, it operates independently of the external, on-line intelligent unit (electronic digital data processing unit 12′). This is a key aspect of the present invention. This means that the interface device 10′ can be carried by the user to different locations and be used to learn music without being tied to a specific instrument or location.

The fact that the interface device 10′ acts independently of the external, intelligent on-line unit (electronic digital data processing unit 12′) once a song file or files has/have been loaded onto the interface device 10′ has the further advantage that the economical and convenient teaching of groups of students is facilitated. Where a wireless connection is used, for example, a single PC, mobile phone, PDA etc can be used to transmit, via BlueTooth, MIDI song file data not just to one but to a plurality of (within-range) interface devices, one interface device 10′ belonging to each student. The students can then use the downloaded file to learn the song at their own pace, by manipulating the “playback” of the track through their personal interface device 10′ and luminary display panel 14′ (the third element) as will be explained later. Furthermore, the students will not all be constrained to remain in the same room. It is not necessary for each student to have their own PC, mobile phone, PDA etc.—one can be used for all students. Where the files are transmitted from the external, online intelligent unit (electronic digital data processing unit 12′) to the interface devices by a wired connection, a central “multi-port” wiring hub connecting to a single PC etc could be used to obviate the need for each student to have their own PC. The wired connection can simply be broken after downloading the desired file(s) to the interface devices of each student, meaning that the students are once again free to move to different locations (and are also free to manipulate the track as they wish).

The user controllable portable interface device 10′ has an interface for user interaction. Control switches (A, 25, 26, 26a in FIG. 3) on the interface device 10′ allow the user to select a song stored in the memory module of the interface device 10′ and to play certain bars of the downloaded song and start/stop/pause/fast-forward or rewind it, for example. The control switches also enable adjustment of the tempo. of the data playback to allow the song to be played at the users own pace of learning. The interface device 10′ also has a simple LED 24/LCD display 27 for information such as tempo, position in song, song selected, battery level, etc.

The user interface on the user controllable portable interface device 10′can be replicated and/or supplemented by a foot pedal. The foot pedal also allows the user to interact with the music file during playback without ever having to take their hands off the instrument they are learning to play, thus enhancing the muscle-memory process. The foot pedal communicates with the interface device 10′ by also using a wireless or hardwired connection. A rocker design with two switches could be used with a combination of short and long presses to prompt different functions (e.g. FF or SKIP). Most preferably, the interface device 10′ relies on the wireless aspects of data transfer.

The embodied electronics have a BlueTooth radio communications interface 21. The Bluetooth transceiver is a bought in OEM module. Given the proximity of the PC, mobile phone or PDA to the instrument, a class 2 (10 metre range) device is sufficient. Class 2 devices are also the standard fitted in Bluetooth enabled PDA devices and mobile phones.

Connection to the embedded host controller 30 in the present embodiment is via a ITL level universal asynchronous receiver and transmitter (UART) as used in RS232 level serial interfaces.

Downloaded MIDI files are written into the memory module 18′ of the interface device 10′, which preferably comprises one of the latest high capacity EEPROM units. Through using the block write capability the data transfer rate is kept as high as possible.

A 24LC256 unit, for example, can store 64K Bytes of information in 128 byte blocks with a storage time of 5 mS per block. This unit restricts the data transfer rate to below the absolute maximum speed of 128×1/0.005=25,600 bytes per second, which relates to a bit rate of approximately 256 KBits per second. Whilst this is below the potential 780 KBits per second data rate of Bluetooth, it is still only a 0.4 second download time for a 10 KByte file (detailed as the most likely amount needed for downloading a song from the intelligent, on-line device). The chipset has the ability to save numerous music files and for the user to manipulate and extrapolate pertinent segments of the sequenced song via the user interface described above.

The interface device 10′ also allows further functionality by means of a metronome and tuning-aid. A metronome provided on the device simply drives the small speaker 29 and/or LED 24 that beeps/flashes at the tempo set by either the musical file being played or set independently by means of the tempo dial 26 on the device itself. In addition, the interface device includes a speaker 29 which can be used along with the LED's to indicate download completion etc, as well as key press acknowledgement, such as with an audible small “click”.

The tuning aid, for example, allows users of stringed instruments to tune or de-tune their instrument by using the interface device 10′, luminary panel 14′ and a device with a microphone, for example a mobile phone, which may be the same mobile phone used to access and download song files to the interface device 10′. As mentioned previously, a software application is downloaded onto the user's mobile phone, and it is this software that is used to communicate with the interface device 10′. The software application is generic and allows for further extensions for different instruments. The software also has a small footprint, enabling it to be implemented on devices with limited capabilities.

To tune their instrument, the user simply places their mobile phone next to the body of the instrument to be tuned, for example, a guitar. They then pluck a string and the microphone on the phone would pick up this analogue wave. The software on the phone then analyses this modal waveform and applies a Fourier algorithm or any equivalent signal-processing algorithm. The software then creates a small MIDI file that correlates the analysed modal waveform into a digital interpretation (e.g. a polyphonic MIDI file). The mobile phone then communicates this MIDI file to the interface device 10′, which in turn powers indicator lights on the luminary panel display 14′ as appropriate to indicate the state of tune of the instrument e.g. very flat, slightly sharp etc. This is an iterative process pending how many times the user needs to pluck the same string until tuning is achieved. When the user plucks a string and no more lights on the panel are lit, they then know the string is tensioned correctly to produce the desired frequency, i.e. is tuned. The tuning process could be achieved by comparing the amplitude spacing (frequency) of a plucked string etc. to a pre-set value stored in memory e.g. 75 Hz for an “E” string, for example. Differences from this stored value can simply be reflected through the illumination of appropriate signal lights seen by the user etc.

To keep costs low, the user controllable portable interface device 10′ has very limited display and processing capabilities. The intelligent, on-line unit (electronic digital data processing unit) 12′ (e.g. a PC), on the other hand, can be expected to have some kind of relatively high-resolution display together with sufficient processing power to drive this display. Use of the present invention allows for upstream synchronisation. This means, information is able to pass from the interface device 10′ back to the intelligent, on-line unit 12′. This would allow, for example, the intelligent, on-line unit 12′ to display additional information, such as song lyrics and chord names, as well as notes and/or chords played by the user of the system using a feedback function of the luminary panel display 14′, described hereinafter. This is termed “live data” since the information is shown at the same time as the lights are lit on the luminary panel display 14. The intelligent unit 12′ may also be used to play additional soundtracks like the melody or rhythm track found on most composed MIDI files.

The user is able to attach a luminary panel display 14′ onto their instrument 20 and connect this display panel 14′ to the interface device 10′. Different luminary panel designs are used for many different instruments, e.g. guitars, piano/keyboard, oboe, flute, etc. The interface device 10′ then drives the luminary panel display 14′ in such a manner as to replicate the stored, musical data. The interface device 10′ has control switches to cater for all this functionality. These basic control functions to be included in the present embodiment are 1. ON; 2. OFF; 3. TUNING; 4. METRONOME; 5. RECEIVE DATA; 6. COMPOSE & SEND DATA.

The interface device 10′ is linked to the luminary panel display 14′, by hard-wiring in order that the power supply of the interface device may fulfil the power requirements of the luminary panel display 14′. Alternatively a wireless connection could be use where the luminary panel display 14′ has its own power supply. The interface device 10′ is provided with a microprocessor and a software application which is capable of transposing MIDI files into electrical signals to be sent to the luminary panel display 14′.

The luminary panel display 14′ itself comprises an array of light sources (for example, LEDs, LEP's, electro-luminescence) set in a tactile strip. The light sources are positioned on the luminary panel display 14′ such that when the panel is placed on an instrument the light sources align with the keys, strings and frets etc of the instrument. The light sources, when lit, are thus indicative of which key or string and fret to play. The electrical signals sent by the interface device 10′ power the light sources such that when a user plays a string at an indicated fret, for example, the user is in fact playing along with the downloaded track.

An example of an electroluminescent display panel 14″ is shown in FIG. 5. The electroluminescent display panel 14″ shown is one suitable for use on a guitar, and includes a thin panel sheet 50, that will be described in more detail below with reference to FIGS. 6 and 7. The panel sheet 50 is of a size that allows it to be inserted under the strings on the fret-board of the guitar. Straps 51, or other suitable means are provided for securing the panel to the guitar. Markers 52 indicate the positions of the frets. Alternatively, the panel may include cut-out slots where the frets lie. The display panel 14″ is provided with indicators on the face of the panel sheet 50, which can be illuminated by provision of suitable power and control signals. The indicators include a set of six pluck indicators 53 (also labelled X1 to X6), one aligned with each of the six guitar strings; and a set of six fret indicators 54 (also labelled L1 to L6, L7 to L12, L13 to L18 etc.) between each of the fret markers 52, again one of each set of six fret indicators 54 being aligned with each of the six guitar strings.

In use, the portable interface device 10′ provides the necessary command signals to illuminate certain indicators. Each pluck indicator 53 illuminated acts as an instruction to the player to pluck that particular string. Each fret indictor 54 illuminated acts as a finger position indicator and an instruction to the player to fret the particular string at the particular fret position of the illuminated indicator.

In addition, on the reverse side of the panel sheet 50, sensors 55 are provided underneath each of the fret indicators 54. These sensors 55 sense pressure from the player's finger when a particular string is being fretted at a particular location. The sensors 55 may be switches or that comprise a tactile switch membrane or capacitative switches formed in a capacitative sensing layer in the panel sheet 50. The sensors 55 provide feedback signals to the interface device as an aid to the tuition process.

FIGS. 6 and 7 show cross-sections through parts of an electroluminescent panel. Referring to FIG. 6, a polyester sheet 60 coated with indium tin oxide (ITO) supports a layer of phosphorescent material 62 at the region where the display may be illuminated. The phosphorescent material 62 is encapsulated between the polyester sheet 60 and a layer of ceramic dielectric 64. A back electrode 66 is connected to a voltage source (not shown) by way of a conductive line 68, while a bus bar electrode 70 acts as a common or neutral voltage rail. When a voltage is supplied to the back electrode, the electric potential causes the phosphorescent material to emit light.

As shown in FIG. 7, multiple back electrodes 72a-72f, each having an individual voltage supply line 74a-74f, may be arranged in a pattern on the ceramic dielectric 64 to provide segmented display (for example so that digits or letter shapes can be illuminated on the display).

The electro-luminescent panels, of the type illustrated in FIGS. 6 and 7, can be as thin as 0.5 mm (substrate thickness plus 200 micrometers). They are flexible and can be bent round simple planar curves. They can also be flexed to allow button pressing through the electro-luminescent display layer. Using electro-luminescent panels with the present invention will also allow dual, luminary displays. As an example, a guitar specific, electro-luminescent panel will have holes in the display to allow super-slim LED's to ‘poke’ through. This secondary LED display would then be dedicated to showing the user which string to pluck, whilst the primary, electro-luminescent display would show the user the notes to play as the music file is sequenced on the user controllable portable device.

The luminary panels described above, employ LEDs, LEP's and electro-luminescent material for example. With regards to electro-luminescence, portions of the panel are made to light up by passing an electrical current through them. This panel could then be placed over a tactile switch membrane or a capacitative sensing layer which would register that certain portions of the panel had been pressed; this feedback data can then be fed-back for display on the screen of the intelligent, online device or user controllable portable interface device or sent to other user controllable portable interface devices as described above.

The luminary panels themselves have dual-purpose functionality. In addition to simply lighting up in sequence to the musical data being played on the interface device, the luminary panels in a preferred embodiment offer a feedback device. This is in the form of membrane switches, capacitative sensing layer, optical sensors or such like, underneath the panel, which sense that a particular portion of the luminary panel and hence a corresponding key etc. of the instrument, has been pressed, and communicate this data back to the user controllable portable device attached to the instrument. The user controllable portable interface device 10′ is set to send this captured data back to the intelligent, online device (electronic digital data processing unit 12′, e.g. a PC) in order that the notes played by the user may be displayed on its screen.

Alternatively, where an interface device 10′ having sufficient display capabilities is used, the feedback information may instead be displayed directly on the interface device 10′ without the need of sending the information to the intelligent, online device. This can be used for synchronisation to allow corrective feedback with the user, i.e. the interface device 10′ will wait until a particular note has been played and then proceed to sequence the next set of lights. An envisaged use of this embodiment is a tuition package within some simple software application that will score the user on how well they managed to follow the lights. This would allow the users to see which parts of the composition they are weak on and be able to data capture those bars of music that need improvement. The user controllable portable interface device 10′ automatically compensates its speed to that of the user's fingering speed. Only when the correct note is fingered, will the device continue to the next lighting sequence. This feature could be made to be a fun learning process for the younger mobile phone users as it will bridge the gap between technology and music.

In a further configuration, the feedback data relayed to the user controllable portable interface device 10′ may be sent to a second, third, fourth, etc user controllable portable interface device. The communication protocol for this one-to-many scenario will be a wireless BlueTooth connection.

This synchronisation would also allow a teacher using the user controllable portable interface device 10′ and a luminary panel equipped with such a two-way functionality to teach a room full of students who would also have their own user controllable portable interface device and luminary panel attached to their instrument.

Only one data source is required—the teacher themselves. The teacher can simply play their instrument and all fingering patterns are sensed, recorded and sent wirelessly to all students in the room. The user controllable portable interface device of each student receives this data from the teacher's user controllable portable interface device, stores and then plays back the data to the student at the student's own pace of learning via their input with the user interface.

This could be taken a step further by facilitating distance learning. A tutor in this instance could simply upload tutorial packages onto a website that will act as a data repository for the software application. Students would then, pending a membership subscription, be able to use their external, on-line units to download relevant pieces of song information that the tutor could recommend.

FIG. 8 is a chart showing user interaction steps/options of three stages in the use of the music tuition system described above. At the top level 801, the portable interface device allows the user two control options. In the first option, the tuition system is enabled by downloading of software and data to the interface device. The second option also allows control of the luminary panel display. The steps 810-817 shown on the left hand branch of FIG. 9 depict the functions for obtaining and downloading of software and data to the remote data holding device (PC or the like). The central branch, steps 820-822, depicts the transferring of the music data to the portable interface device. The right hand branch, steps 830-843, depicts the use of the device to control the luminary panel display when mounted to the musical instrument. The steps indicated are as follows.

810. Turn on PC/PDA or mobile phone

811. Start application residing on users intelligent on-line unit

812. Retrieve MIDI file(s) by either
813—Surfing the internet
814—Using stored songs in application
815—Using website
816—Purchasing CD's or SDIO cards
817—Mobile phone downloads by GPRS or similar

820. Transmit data from intelligent on-line unit by either
821—BlueTooth connection—or
822—a USB connection

830. Turn on portable device

831. Auto-detect data transfer by either:
832—BlueTooth connection—or
833—a USB connection

834. Cache data into onboard, non-volatile memory.
Once stored the user can then interact (step 835) by either:
836—using the interface on portable device allowing control of play, pause, rewind, fast-forward, button A and tempo control 840-842;
837—using the GUI on the intelligent, on-line unit- or
838—using a foot pedal to 843 play, pause, rewind and fast-forward the current file.

Variants

Another envisaged use of the present invention will be synchronised MP3 playback. In general, it is difficult to synchronise a MDI track with an MP3 recording of an actual artist performing that piece. The MDI file has strict timing (but the speed is adjustable) whereas the MP3 has non-adjustable speed. However, it may be possible to synchronise a particular MIDI file with a particular recording if synchronisation information is added to the song file when it is produced. This may be done by creating a 3^{rd} file, for example. This would just guide the synchronised timeline of the MP3/MDI files by use of time-stamps for example. I.e. the software would always make sure the MP3 is playing (on users phone perhaps) in exact time with the MDI file that has been used to light the luminary panel. An envisaged use of the present invention shall be the ability for the user controllable portable interface device to be driven directly from uploaded MP3 (and such like) and consequently driving the luminary panel. These MP3 files would contain far more raw data than a MDI file and would subsequently be able to offer the user far more interaction and manipulation with music in its ‘raw’ format. The user will then be able to adjust the MP3 playback speed to the speed of the MIDI file playback (using upstream synchronisation). This would allow the user to hear exactly how the music is played from an original soundtrack whilst at the same time using the polyphonic, MIDI file as a backbone as to the structure and composition of the song.

Another function of the present embodiment is to use a Musical Instrument Digital Interface (MDI) connection. This would allow connection between the designed electronics on the user controllable portable interface device and a MIDI equipped device such as a keyboard. Controls on the user controllable portable interface device would allow the recording of notes played on the keyboard to be played back on the luminary display or stored in the EEPROM and possibly transferred back to the PDA, mobile phone or PC device for user manipulation. The keyboard user could then upload their music to a central repository making it available for users having their own user controllable portable interface device.

It is desired that a stripped-down embodiment containing all the necessary electronics will fit into an encapsulated module the size of a small matchbox. This would then ‘click’ into future mobile phones USB slot or similar interface. Users could then have their own high-resolution interface clamped onto their instrument by way of the mobile phones screen. The matchbox of electronics would then be able to drive peripheral devices such as the luminary panel described above.

It is also to be appreciated that the above-described embodiment could also be used generally as a device interface. For example, the matchbox of electronics could be used to drive a portable weather station, blood-pressure taking, insulin level checker, memory stick, etc. In this arrangement, the control device 16 and the display 14 of FIG. 1 are contained together in the mobile phone or other similar device. The remote data holding device 12, instead of being a device that is used to provides data files to the interface device 10, is a device that is configured to be activated to acquire and/or record data, such as the examples above. The interface device 10 may be configured to send instructions to the remote data holding device 12 to instruct it to obtain and/or retrieve data that is then transmitted back to the interface device 10. Software in the memory 18 then interprets the data and sends information for display to the user on the display 14. The interface device could access any number of a variety of such remote data holding devices.

FIG. 9 depicts a system configured with an interface device 110. A mobile telephone 116 having a display screen 114 and a USB connection 120 that connects into a corresponding USB port on the interface device 110. A wrist-band 118 provides an alternative to the mobile telephone 116, and communicates with the interface device 110 either by way of a cable or by wireless means (Bluetooth). Three examples of remote data holding devices are shown. One is a health checker 112, which is a device that can be wrapped around a limb (e.g. a finger) and using non-invasive sensors obtains a measure of blood pressure, pulse and blood insulin level. Another is a remote weather station that monitors weather data such as wind speed and direction, atmospheric temperature and pressure, and air humidity. Each of the remote devices 112, 122, is equipped with a wireless Bluetooth transceiver (not shown). The third remote device shown is an MP3 player 132 in a user's pocket.

In one configuration, a user can attach the mobile phone 116 to the interface device 110 via the USB connection 120. The user can now use the mobile phone buttons to control the interface device 110 and instruct it to obtain information from a remote device. For example, if the user wishes to receive a health check of a person wearing the health checker 112, the interface device 110 is instructed to retrieve the data from the health checker 112. This it does by transmitting commands to the health checker 112, which instruct the health checker 112 to take readings of the wearer's blood pressure, pulse, etc. The health checker 112 then transmits the data back to the interface device 110, where it is processed into a form suitable for display to the user on the display of the mobile phone 116.

A similar approach may be used to obtain weather data from the remote weather station 122. The data retrieved can then be processed by the interface device 110 and displayed to the user in the form of a weather report or weather forecast. This system is one that might be used, for example, by mountaineers or ramblers.

In an alternative arrangement, the portable display device may comprise a control panel and display that is remote from the interface device. For example, in FIG. 9, a light band 118, worn around a user's wrist is linked to the interface device 110 for two-way communications with the interface device, which may be wireless (e.g. Bluetooth) or by way of a cable. The light band 118 may also be releasably attached by Velcro™ onto the sleeve of a coat (not shown). In this embodiment, the light band 118 is configured to communicate via the interface device 110 to control operation of a remote device 112, 122, 132. For example, the remote device may be an MP3 player 132 that would otherwise be inaccessible in the user's coat pocket (see 132, FIG. 9). In this way the user has a readily accessible means to control the playing of music on the MP3 player 132, without having to remove it from the pocket.

The user controllable portable interface device would then take on a similar function as the Windows™ product. Here, Windows offers a transparent layer to users of many different makes and models of personal computers. Windows just gets into the guts of the user's PC hardware and then creates a standardized user interface. This negates the need for users to understand their pc's architecture every time they wish to upgrade to a new PC. The user controllable portable device using the matchbox of electronics offers the same functionality but for the sake of the hardware.

1.-53. (canceled)

54. A music tuition system comprising:
an electronic digital data processing unit capable of accessing a store of electronic music data of a pre-determined format;
a luminary display mountable on a musical instrument; and
a user controllable portable electronic interface device, which is removably mountable to the musical instrument and includes: means for receiving electronic data that includes music data from the data processing unit; a memory for storing data including said music data; means for generating command signals for controlling the luminary display in accordance with a sequence determined from said music data; and means for a user to control output of the music data to the luminary display.

55. The music tuition system of claim 54 wherein the data processing unit comprises an external, intelligent, on-line unit.

56. The music tuition system of claim 55 wherein the data processing unit comprises a personal computer (PC), a personal digital assistant (PDA) or a mobile telephone capable of accessing a store of electronic music files via the internet.

57. The music tuition system of claim 54, wherein the electronic music data files are in MIDI (Musical Instrument Digital Interface) format.

58. The music tuition system of claim 54, wherein the electronic music data files are in MP3 format.

59. The music tuition system of claim 54, wherein the music data received by the interface device comprises the electronic music data file in the predetermined format.

60. The music tuition system of claim 59 wherein the interface device is operable for transposing the electronic music data file into the command signals for controlling the illuminated display.

61. The music tuition system of claim 54 wherein the music data received by the interface device comprises command signal data.

62. The music tuition system of claim 62 wherein the data processing unit is operable for downloading the electronic music data files, transposing them and then transmitting the music data including the command signal data to the interface device.

63. The music tuition system according to claim 54, wherein the interface device is operable to provide power the luminary panel.

64. The music tuition system of claim 54, wherein data is downloaded via either a wireless (for example BlueTooth) or hardwired (for example USB) connection.

65. The music tuition system of claim 64, wherein on download, the data is stored into a non-volatile memory module of the user controllable portable interface device.

66. The music tuition system of claim 54 wherein the luminary display comprises an electro-luminescent, luminary panel.

67. The music tuition system of claim 54 wherein the luminary display comprises LEP's (Light Emitting Polymers)

68. The music tuition system of claim 54 wherein the luminary display comprises super-slim LED's (Light Emitting Diodes).

69. The music tuition system of claim 54 wherein the luminary display is a positional display indicator panel.

70. The music tuition system of claim 69 wherein the user controllable, interface device is able to drive different luminary panels that are attachable to different instruments.

71. The music tuition system of claim 69, wherein where the instrument is a stringed instrument, the luminary panel is operable to display to the user which strings to play on their instrument.

72. The music tuition system of claim 71 wherein the luminary panel is also operable to display to the user where to “fret” a string on the instrument and to indicate that an open, unfretted string is to be played.

73. The music tuition system of claim 71, wherein the luminary display panel is attachable onto a neck of the instrument under the strings.

74. The music tuition system of claim 69, wherein the instrument has a keyboard, the display panel being operable to display which keys of a keyboard are to be played.

75. The music tuition system of claim 74, wherein the luminary display is attachable on top of the keyboard.

76. The music tuition system of claim 69 wherein the instrument is a wind instrument, the luminary display panel being attachable wrapping around the instrument.

77. The music tuition system of claim 69 wherein the luminary panel has a nominal thickness and as such forms a membrane so that when the panel is attached to the desired instrument, it provides negligible aesthetic intervention.

78. A user controllable portable electronic interface device, which is removably mountable to a musical instrument without impairing playing of the instrument and operable for providing command signals for control of a luminary display on said instrument, wherein the interface device comprises:
a memory for storing electronic data that includes music data;
means for generating said command signals for controlling the luminary display in accordance with a sequence determined from said music data;
means for receiving said electronic data for storage in the memory; and
means for a user to control output of the command signals to the luminary display.

79. The electronic interface device of claim 78, operable for transposing the electronic music data file into the command signals for controlling the illuminated display.

80. The electronic interface device of claim 78, wherein the music data received by the interface device comprises command signal data.

81. The electronic interface device of claims 78, operable to provide power to the luminary panel.

82. The electronic interface device of claims 78, operable to receive data via either a wireless (for example BlueTooth) or hardwired (for example USB) connection.

83. The electronic interface device of claim 78, wherein data is stored into a non-volatile memory module of the interface device.

84. The electronic interface device of claim 78, further comprising means for connection to a keyboard.

85. The electronic interface device of claim 78 comprising control features on the interface device for allowing a user to control transfer of data to/from the interface device.

86. The electronic interface device of claim 78, comprising means for a user to control tempo of the command signals to the luminary display.

87. The electronic interface device of claim 78 comprising a metronome.

88. The electronic interface device of claim 87 wherein the metronome flashes an LED at a speed determined by the user.

89. The electronic interface device of claim 78 comprising an LCD for displaying information about the music data to the user.

90. The electronic interface device of claim 78 comprising a speaker for providing an acoustic output.

91. The music tuition system of claim 54, further comprising a complimentary foot pedal for providing control signals to the interface device that mirrors and/or supplement the controls on the interface device.

92. The music tuition system of claim 91, wherein the foot pedal communicates with the interface device using hard-wired (e.g. USB) or wireless (e.g. BlueTooth) communications.

93. A music tuition method comprising:
accessing a store of electronic music data of a pre-determined format;
transmitting music data to a user controllable portable electronic interface device that is removably mountable to a musical instrument;
storing the music data in a memory on the interface device;
mounting the interface device on the musical instrument; and
controlling the interface device to generate command signals for operating an illuminated display on the musical instrument in accordance with a sequence determined from said music data.

94. An electronic data communications system that includes a portable electronic interface device comprising:
a memory for storing data and software; first transceiver means for two-way communications with a remote data acquisition device;
second transceiver means operable for two-way communications with a portable display device; and
a processor for implementing instructions contained in said software to cause said interface device to transmit signals for controlling said remote device to acquire data, to retrieve said acquired data therefrom, and to transmit information based on said retrieved data to said portable display device for display thereon.

95. The electronic data communications system of claim 94, wherein the interface device comprises user operable control features enabling a user to control operation of the device.

96. The electronic data communications system of claim 94, wherein the portable display device comprises user operable control features for enabling a user to generate control signals for transmission via the second transceiver means to the remote device for control thereof.

97. The electronic data communications system of claim 94, wherein the portable display device is a light band worn on a user's wrist or releasably attachable to a user's clothing.

98. The electronic data communications system of claim 96, wherein the portable display device is a mobile telephone or similar device.

99. The electronic data communications system of claim 94, wherein the remote device monitors sensors or apparatus for obtaining physical data.

100. The electronic data communications system of claim 99, wherein the remote device is a health checker.

101. The electronic data communications system of claim 100, wherein the health checker is operable for monitoring any or all of blood pressure, body temperature, pulse rate, insulin level.

102. The electronic data communications system of claims 94, wherein the remote device is a weather station.

103. The electronic data communications system of claim 102, wherein the weather station is operable for obtaining data relating to any or all of, wind speed, wind direction, atmospheric temperature, pressure and humidity.

104. The electronic data communications system of claim 94, wherein the remote device is a portable music-playing device, such as an MP3 player.

105. The electronic interface device of claim 78, further comprising a complimentary foot pedal for providing control signals to the interface device that mirrors and/or supplement the controls on the interface device.

106. The interface device of claim 91, wherein the foot pedal communicates with the interface device using hard-wired (e.g. USB) or wireless (e.g. BlueTooth) communications.
